(19) United States
(12) Patent Application Publication
(10) Pub. No.: US 2010/0295697 A1
(43) Pub. Date: Nov. 25, 2010

(54) MULTIMEDIA DEVICE, REMOTE CONTROL DEVICE AND MULTIMEDIA SYSTEM

(76) Inventor: Kuang-Feng Sung, Taichung County (TW)

Correspondence Address: NORTH AMERICA INTELLECTUAL PROPERTY CORPORATION, P.O. BOX 506, MERRIFIELD, VA, 22116, US

(21) Appl. No.: 12/501,480

(22) Filed: Jul. 12, 2009

(30) Foreign Application Priority Data
May 22, 2009 (TW) 098116970

(51) Int. Cl. G05B 19/02; G06F 3/041

(52) U.S. Cl. 340/825.22; 345/173

(57) ABSTRACT

A multimedia device is disclosed. The multimedia device includes an operating circuit, a wireless receiver for wirelessly receiving a touch signal, a function determining unit coupled to the wireless receiver for determining a corresponding function and generating a determination result according to the touch signal, and a control unit coupled to the operating circuit and the function determining unit for controlling the operating circuit to perform the function according to the determination result.

### BACKGROUND OF THE INVENTION

1. Field of the Invention

The present invention relates to a multimedia device, remote control device and multimedia system, and more particularly, to a multimedia device, remote control device and multimedia system that has enhanced convenience of use.

2. Description of the Prior Art

With advancements in multimedia technology, all kinds of multimedia devices have become part of modern life. Multimedia products such as televisions, audio systems, projectors, digital DVD players, etc. are commonly used by society. For a user to conveniently operate each function of these multimedia devices, many multimedia devices are equipped with a corresponding remote control, for allowing users to operate the multimedia device via the remote control.

When the user wants to operate the multimedia device to perform a function, the user can press the key corresponding to the function on the remote control, wherein the remote control signal outputted from the remote control carries the specific data corresponding to the function. After the multimedia device receives the remote control signal, the multimedia device can determine the specific data in the remote control signal and perform related functions. In the prior art, a push-button remote control is the most common type of remote control; however, the size of the characters displayed on the remote control is limited, which can cause inconvenience for a user with poor eyesight. In particular, this type of device is ill suited for the older members of society. For example, when a user with presbyopia wants to use the push-button remote control, the user must wear glasses to operate the remote control, and then has to remove the glasses when watching the television. Each time the user operates the remote control this action must be repeated, which causes an unnecessary inconvenience for the user. An improvement to this system is desired.

### SUMMARY OF THE INVENTION

It is therefore a primary objective of the claimed invention to provide related devices for improving a remote control device controlling a multimedia device in a multimedia system.

The present invention discloses a multimedia device, which comprises: an operating circuit; a wireless receiver, for receiving a touch signal via a wireless communication method; a function determining unit, coupled to the wireless receiver, for determining an operating function corresponding to the touch signal to generate a determination result according to the touch signal; and a control unit, coupled to the operating circuit and the function determining unit, for controlling the operating circuit to execute the operating function according to the determination result.

The present invention further discloses a multimedia system, which comprises a remote control device and a multimedia device. The remote control device comprises: a touch pad, for detecting a touch signal; and a wireless signal transmitter, coupled to the touch pad, for transmitting the touch signal via a wireless communication method. The multimedia device comprises: an operating circuit; a wireless receiver, for receiving the touch signal via the wireless communication method; a function determining unit, coupled to the wireless receiver, for determining an operating function corresponding to the touch signal to generate a determination result according to the touch signal; and a control unit, coupled to the operating circuit and the function determining unit, for controlling the operating circuit to execute the operating function according to the determination result.

The present invention further discloses a remote control device utilized for controlling a multimedia device. The remote control device comprises: a touch pad, for detecting a touch signal; a signal determining unit, coupled to the touch pad, for determining an operating function corresponding to the touch signal to output an indication signal according to the touch signal; and a wireless signal transmitter, coupled to the signal determining unit, utilized for transmitting the indication signal to the multimedia device via a wireless communication method, for controlling the multimedia device to execute the operating function.

The present invention further discloses a multimedia system and a multimedia device. The multimedia system comprises: a touch pad, for detecting a touch signal; a signal determining unit, coupled to the touch pad, for determining an operating function corresponding to the touch signal to output an indication signal according to the touch signal; and a wireless signal transmitter, coupled to the signal determining unit, for transmitting the indication signal via a wireless communication method. The multimedia device comprises: an operating circuit; a wireless receiver, for receiving the indication signal via the wireless communication method; and a control unit, coupled to the operating circuit and the wireless receiver, for controlling the operating circuit to execute the operating function according to the indication signal.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram of a multimedia system according to an embodiment of the present invention.

FIG. 2 is a schematic diagram of the multimedia device shown in FIG. 1 setting definitions of operating function according to an embodiment of the present invention.

FIG. 3 is a schematic diagram of a function display of the multimedia device shown in FIG. 1 according to an embodiment of the present invention.

FIG. 4 is a schematic diagram of a multimedia system according to an embodiment of the present invention.

FIG. 5 is a schematic diagram of a remote control device setting definitions of operating functions of the multimedia device shown in FIG. 4 according to an embodiment of the present invention.

### DETAILED DESCRIPTION

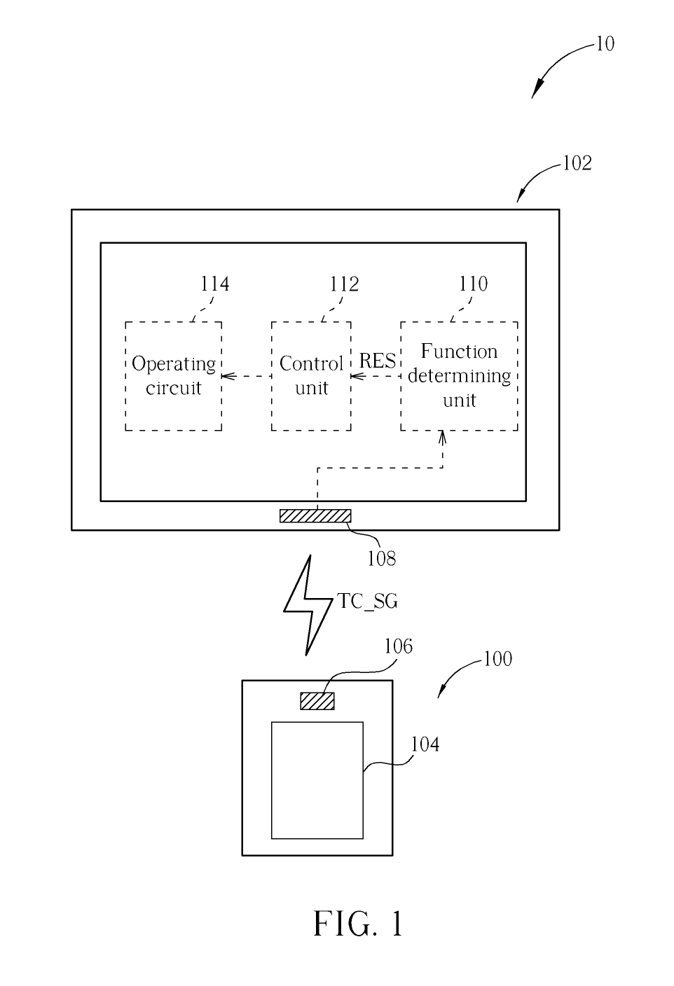

Please refer to FIG. 1, which is a schematic diagram of a multimedia system 10 according to an embodiment of the present invention. The multimedia system 10 can enhance convenience of use and prevent the inconvenience involved with a user operating a multimedia system with small-sized keys. The multimedia system 10 comprises a remote control device 100 and a multimedia device 102. The remote control device 100 is utilized for wirelessly (via infrared, radio frequency, wireless network means etc.) controlling the multimedia device 102 including a touch pad 104 and a wireless signal transmitter 106. The touch pad 104 is utilized for detecting a touch signal TC_SG of the user and the wireless signal transmitter 106 is utilized for wirelessly transmitting the touch signal TC_SG to the multimedia device 102. The multimedia device 102 is preferably a display device such as a television, projector, etc., which includes an operating circuit 114, a wireless receiver 108, a function determining unit 110 and a control unit 112. The operating circuit 114 is utilized for realizing the functions of the multimedia device 102. The wireless receiver 108 is utilized for wirelessly receiving the touch signal TC_SG outputted from the wireless signal transmitter 106 and transmitting the touch signal TC_SG to the function determining unit 110. The function determining unit 110 can determine an operating function corresponding to the touch signal TC_SG to generate a determination result RES according to the touch signal TC_SG. The control unit 112 coupled to the operating circuit 114 and the function determining unit 110 is utilized for controlling the operating function of the operating circuit 114 according to the determination result RES of the function determining unit 110.

The remote control device 100 detects the touch signal TC_SG of the user via the touch pad 104 and wirelessly transmits the touch signal TC_SG to the multimedia device 102 via the wireless signal transmitter 106. In the multimedia device 102, the function determining unit 110 can determine the operating function corresponding to the touch signal TC_SG, and the control unit 112 can control the operating circuit 114 to perform related functions. Under these circumstances, the user can control the multimedia device 102 by utilizing a touch method instead of the traditional push-button method, thereby improving the inconvenience caused by small-sized keys of the traditional remote control.

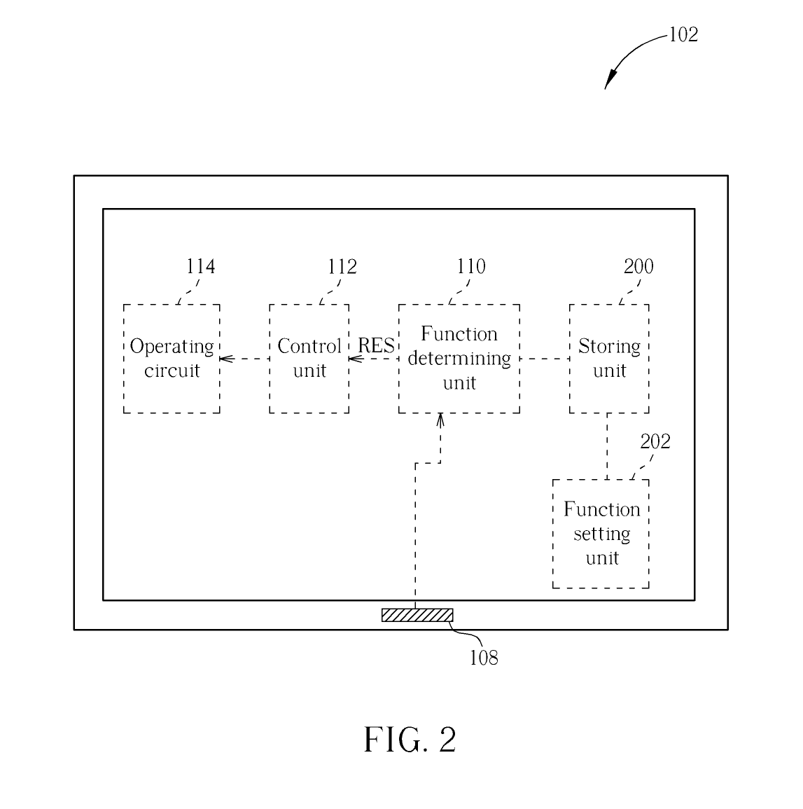

Please note that the multimedia system 10 shown in FIG. 1 is one embodiment of the present invention, and those skilled in the art can make modifications and alterations according to different requirements, which are not narrated herein. For example, in order to set up the definitions of different touch signals TC_SG corresponding to the operating functions, the multimedia device 102 further comprises a storing unit 200 and a function setting unit 202, which are shown in FIG. 2. The storing unit 200 coupled to the function determining unit 110 is utilized for storing the definitions of the touch signals TC_SG corresponding to the operating functions, by storing different finger movements (such as slide, press, double-click or movements with multiple fingers etc.) and their corresponding operating functions. The function setting unit 202 coupled to the storing unit 200 is utilized for setting up the definitions of the touch signal TC_SG and the corresponding operating functions, for allowing the user to set up different touch signals TC_SG according to individual habits and requirements. For example, via the function setting unit 202 the user can set up functions such as choosing the next channel by sliding the finger to the right, choosing the previous channel by sliding the finger to the left, increasing the volume by sliding the finger up, decreasing the volume by sliding the finger down, etc., and related settings into the storing unit 200.

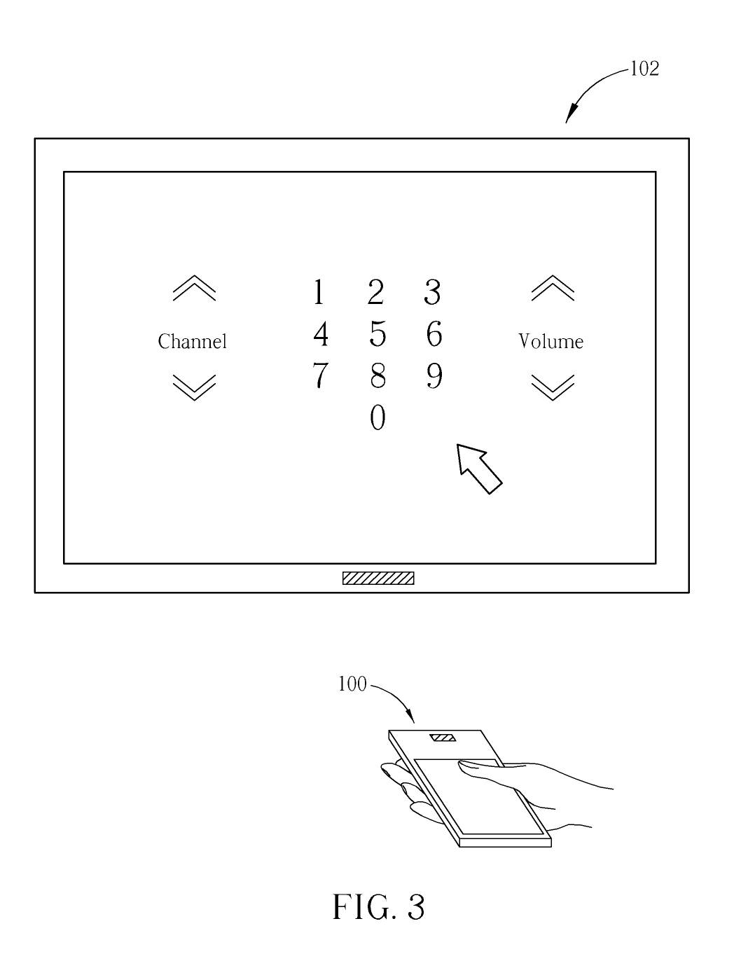

Furthermore, to further improve convenience, the present invention can display related operating functions on the screen of the multimedia device 102. For example, in FIG. 3, assuming that two fingers double clicking the touch pad 104 represents activating a user menu, then the user can control the cursor movement on the screen by moving the finger on the touch pad 104, and the user can also select the operating function that the cursor points to such as volume adjustment, channel selection, etc. by single clicking the touch pad 104. Under the circumstances, the user can keep their eyes on the screen by moving the fingers on the touch pad 104 to control each operating function of the multimedia device 102 instead of switching their focus to the remote control device 100. Since the user menu is displayed on the screen of the multimedia device 102, convenience of operation is significantly improved.

In FIG. 1, determination of which function the user wishes to operate is performed by the multimedia device 102. That is, the remote control 100 transforms the user touch movements, such as slide, press, double-click, etc. into the digital touch signals TC_SG, and transmits the touch signals TC_SG to the multimedia device 102 via wireless communication methods. Related functions are determined by the function determining unit 110 of the multimedia device 102 and performed by the operating circuit 114 which is controlled by the control unit 112. In addition, the present invention can further perform function determination via the remote control device.

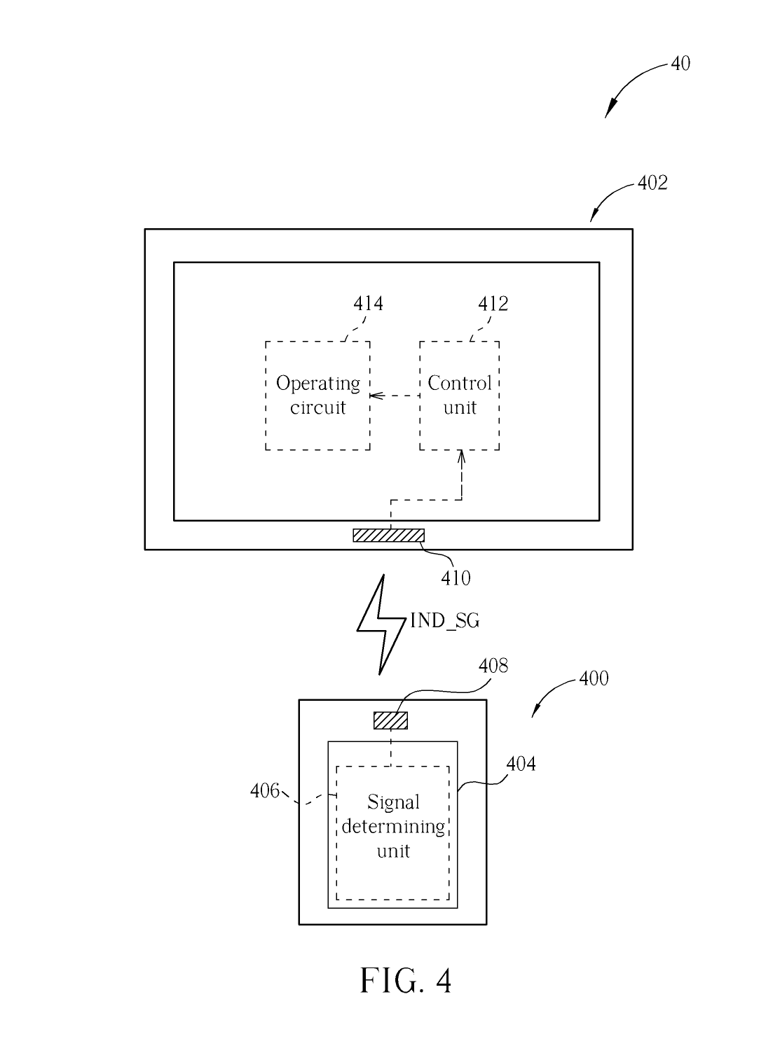

Please refer to FIG. 4, which is a schematic diagram of a multimedia system 40 according to an embodiment of the present invention. The multimedia system 40 comprises a remote control device 400 and a multimedia device 402. The remote control device 400 is utilized for controlling the multimedia device 402 via wireless communication methods (such as infrared, radio frequency, wireless network, etc.), and the multimedia device 402 comprises a touch pad 404, a signal determining unit 406 and a wireless signal transmitter 408. The touch pad 404 is utilized for detecting the touch signal TC_SG of the user. The signal determining unit 406 coupled to the touch pad 404 is utilized for determining the corresponding operating function according to the touch signal TC_SG and outputting an indication signal IND_SG. The wireless signal transmitter 408 coupled to the signal determining unit 406 is utilized for transmitting the indication signal IND_SG to the multimedia device 402 via the wireless communication method. The multimedia device 402 is preferably a display device such as a television, a projector, etc., which comprises a wireless receiver 410, a control unit 412 and an operating circuit 414. The wireless receiver 410 is utilized for receiving the indication signal IND_SG via the wireless communication method, and the control unit 412 coupled to the wireless receiver 410 and the operating circuit 414 is utilized for controlling the operating circuit 414 to perform the operating function according to the indication signal IND_SG.

The remote control device 400 detects the touch signal TC_SG of the user and transforms the touch signal TC_SG into the indication signal IND_SG transmitted from the traditional remote control, for allowing the multimedia device 402 to perform the corresponding operating function according to the indication signal IND_SG. Under the circumstances, the user can control the multimedia device 402 via the touch method instead of the traditional push-button method, thereby avoiding the inconvenience caused by small keys that cannot be operated easily or conveniently. Also, the user can purchase a suitable brand of remote control device 400 that matches the original brand of the owned multimedia device 402 without replacing the multimedia device 402.

In detail, in the multimedia system 40, the remote control device 400 not only detects the user touch movement, but also determines the operating functions corresponding to different touch movements, and finally outputs the indication signals IND_SG to the multimedia device 402. Therefore, if the user wants to avoid the disadvantages of small-sized keys of the remote control, the user can purchase the remote control device 400 matching the multimedia device 402. Consequently, the user can control the multimedia device 402 via the touch method instead of using the traditional push-button method and there is no need to replace the multimedia device 402 at the same time.

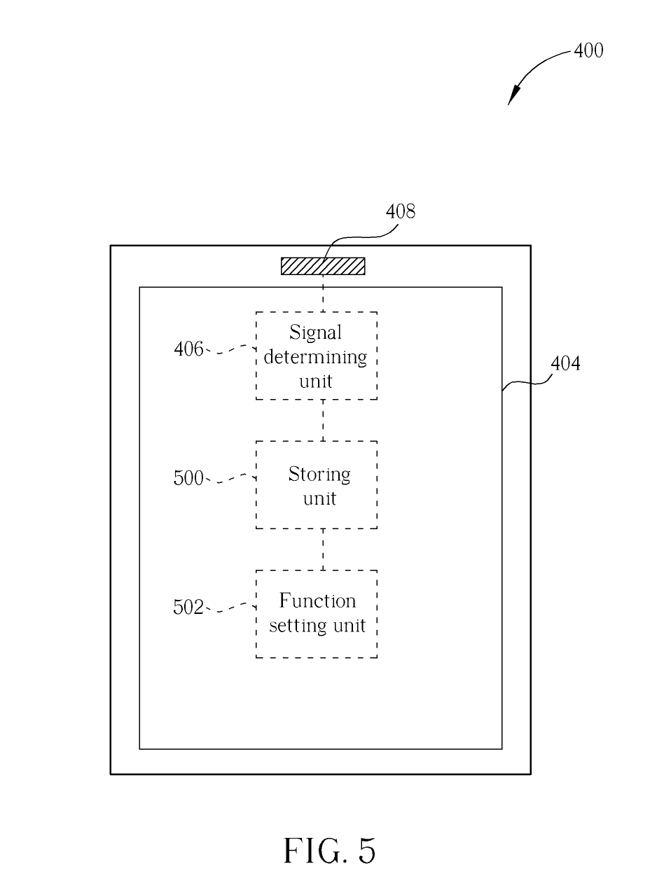

Please note that the multimedia system 40 shown in FIG. 4 is one embodiment of the present invention, and those skilled in the art can make modifications and alterations according to different requirements, which are not narrated herein. For example, to set up the definitions of different touch signals TC_SG corresponding to the operating functions, the remote control device 400 can further comprise a storing unit 500 and a function setting unit 502 as shown in FIG. 5. The storing unit 500 coupled to the signal determining unit 406 is utilized for storing the definitions of the touch signals TC_SG corresponding to the operating functions, by storing different finger movements (such as slide, press, double-click or movements with multiple fingers etc.) and their corresponding operating functions. The function setting unit 502 coupled to the storing unit 500 is utilized for setting up the definition of the touch signals TC_SG corresponding to the operating functions, for allowing the user to set up different touch signals TC_SG according to individual habits and requirements. For example, via the function setting unit 502, the user can set up functions such as choosing the next channel by sliding the finger to the right, choosing the previous channel by sliding the finger to the left, increasing the volume by sliding the finger up, decreasing the volume by sliding the finger down, etc., and related settings into the storing unit 500. Related operating functions displayed on the screen of the multimedia device 402 are shown in FIG. 3. The related illustration is not narrated herein.

In the prior art, the size of the keys on the traditional push-button remote control is limited, causing inconvenience especially for users with poor eyesight, and resulting in users with presbyopia having to repeatedly put on and take off glasses when operating the remote control and watching the television, which does not conform to the requirements of an aging society. In comparison, the present invention is formed on the touch pad of the remote control device and allows the user to control the operating functions of the multimedia device by utilizing a touch method instead of the push-button remote control, so as to avoid the inconvenience caused by small-sized keys. To reach the above-mentioned purpose, the present invention provides two embodiments (FIG. 1 and FIG. 4) for different requirements. Taking FIG. 1 as an example, the remote control device 100 simply transforms the user touch movements into the touch signals TC_SG and transmits the touch signals TC_SG to the multimedia device 102 via wireless communication methods. Therefore, complexity of the electronic circuit of the remote control device 100 is lowered and the power consumption is reduced. Taking FIG. 4 as an example, the user can purchase the appropriate remote control device 400 to suit the brand or model of the multimedia device 402 without replacing the original multimedia device 402.

To sum up, the present invention operates the multimedia device via a touch method by using fingers or touch pens to perform corresponding operating functions. Consequently, the user can keep their focus on the multimedia device, allowing the user to operate the multimedia device easily and conveniently.

Those skilled in the art will readily observe that numerous modifications and alterations of the device and method may be made while retaining the teachings of the invention.

What is claimed is:

1. A multimedia device comprising:
an operating circuit;
a wireless receiver, for receiving a touch signal via a wireless communication method;
a function determining unit, coupled to the wireless receiver, for determining an operating function corresponding to the touch signal to generate a determination result according to the touch signal; and
a control unit, coupled to the operating circuit and the function determining unit, for controlling the operating circuit to execute the operating function according to the determination result.

2. The multimedia device of claim 1 further comprising:
a storing unit coupled to the function determining unit, for storing definitions of the touch signal and the operating function.

3. The multimedia device of claim 2 further comprising:
a function setting unit coupled to the storing unit, for setting the definitions of the touch signal and the operating function.

4. The multimedia device of claim 1, wherein the multimedia device is a television.

5. A multimedia system comprising:
a remote control device, comprising:
a touch pad, for detecting a touch signal; and
a wireless signal transmitter, coupled to the touch pad, for transmitting the touch signal via a wireless communication method; and
a multimedia device, comprising:
an operating circuit;
a wireless receiver, for receiving the touch signal via the wireless communication method;
a function determining unit, coupled to the wireless receiver, for determining an operating function corresponding to the touch signal to generate a determination result according to the touch signal; and
a control unit, coupled to the operating circuit and the function determining unit, for controlling the operating circuit to execute the operating function according to the determination result.

6. The multimedia system of claim 5, wherein the multimedia device further comprises a storing unit coupled to the function determining unit, for storing definitions of the touch signal and the operating function.

7. The multimedia system of claim 6, wherein the multimedia device further comprises a function setting unit coupled to the storing unit, for setting the definitions of the touch signal and the operating function.

8. The multimedia system of claim 5, wherein the multimedia device is a television.

9. A remote control device utilized for controlling a multimedia device comprising:
a touch pad, for detecting a touch signal;
a signal determining unit, coupled to the touch pad, for determining an operating function corresponding to the touch signal to output an indication signal according to the touch signal; and
a wireless signal transmitter, coupled to the signal determining unit, utilized for transmitting the indication signal to the multimedia device via a wireless communication method, for controlling the multimedia device to execute the operating function.

10. The remote control device of claim 9 further comprising:
a storing unit coupled to the signal determining unit, for storing definitions of the touch signal and the operating function.

11. The remote control device of claim 10 further comprising:
a function setting unit coupled to the storing unit, for setting the definitions of the touch signal and the operating function.

12. The remote control device of claim 9, wherein the multimedia device is a television.

13. A multimedia system comprising:
a remote control device, comprising:
a touch pad, for detecting a touch signal;
a signal determining unit, coupled to the touch pad, for determining an operating function corresponding to the touch signal to output an indication signal according to the touch signal; and
a wireless signal transmitter, coupled to the signal determining unit, for transmitting the indication signal via a wireless communication method; and
a multimedia device, comprising:
an operating circuit;
a wireless receiver, for receiving the indication signal via the wireless communication method; and
a control unit, coupled to the operating circuit and the wireless receiver, for controlling the operating circuit to execute the operating function according to the indication signal.

14. The multimedia system of claim 13, wherein the remote control device further comprises a storing unit coupled to the signal function determining unit, for storing definitions of the touch signal and the operating function.

15. The multimedia system of claim 14, wherein the remote control device further comprises a function setting unit coupled to the storing unit, for setting the definitions of the touch signal and the operating function.

16. The multimedia system of claim 13, wherein the multimedia device is a television.
